(19) United States
(12) Patent Application Publication
(10) Pub. No.: US 2020/0141387 A1
(43) Pub. Date: May 7, 2020

(54) AN APPARATUS FOR GENERATING POWER TO OPERATE TELECOMMUNICATION NETWORKS USING VERTICAL AXIS WIND TURBINES

(71) Applicant: MUTHAIAH BALAGURUSWAMY, BANGALORE (IN)

(72) Inventors: MUTHAIAH BALAGURUSWAMY, BANGALORE (IN); PRASHANT BANGALORE NINGAIAH, BANGALORE (IN); ARUN MEENAKSHI SUNDARAM, BANGALORE (IN)

(21) Appl. No.: 16/622,299

(22) PCT Filed: Jun. 13, 2018
(86) PCT No.: PCT/IB2018/054277

§ 371 Date: Dec. 13, 2019

(30) Foreign Application Priority Data
Jun. 16, 2017 (IN) 201741021128

(51) Int. Cl. F03D 9/43; F03D 3/00; F03D 9/25; F03D 80/30

(52) U.S. Cl. CPC F03D 9/43; F03D 80/30; F03D 9/25; F03D 3/005

(57) ABSTRACT

The present invention relates to an apparatus for generating power to operate telecommunication network system (401) comprises of a vertical wind turbine, a generator (302) and a Faraday cage (106). The vertical wind turbine includes a hub, a hollow rotating vertical shaft (105), a rotor, plurality of blades (107), and a brake mechanism. The hub attached on to the shaft to which the blades (107) are attached. The hollow rotating vertical shaft (105) is connected to the hub that in turn connected to the generator (302). The shaft (105) is mounted on top of the telecommunication network system (401). The shaft (105) is provided to transfer the rotation of blades (107) due to wind energy to the generator (302) and thereby to convert the wind energy to electrical energy. The Faraday cage (106) is wrapped around the generator (302) to avoid electromagnetic interference and lightning.

### FIELD OF INVENTION

The embodiment herein generally relates to a utilization of renewable energy plant for generating power to operate telecommunication networks. Particularly, the invention provides an apparatus for generating power to operate telecommunication networks using vertical axis wind turbines.

### BACKGROUND AND PRIOR ART

The demand of electricity is increasing every day in a large scale. The current production of electricity is scarce. The limited power generation has to also be utilized for lighting up roadways which is unavoidable. Telecommunication networks also require high amount of power for operation. This difference in demand and supply leads to insufficient supply of electric current. A much effective power generation solution is the need of the hour now.

Telecommunication towers which include antennas and often radio equipment are utilized throughout all areas of India and other countries. These towers are usually powered by domestic local power supply and in remote areas sometimes by battery power, fuel cells, propane or diesel power. The demand of electricity is increasing every day in large scale whereas the current production of electricity is scarce. To overcome such problems many unconventional solutions have been provided by the scientists. Lot of researches is being conducted in the renewable energy field. One of such renewable energy source is wind.

In currently known telecommunication towers for telecommunication networks, in case the electric energy cannot be directly supplied, use is made of local generating sets (power units), notwithstanding their costs. At present in India there are hundreds of stations located in hardly accessible places and there are several hundred places where there is no presence of telecommunication network system due to unavailability of power related infrastructures in that area. These are the places where it is required to make use of said indirect supply by employing a locally installed electricity generator.

Consequently the local population does not want the presence of noisy, radiation emitting and unsightly tall towers in their neighborhood. In today's market the horizontal axis wind turbine is most widely recognized sort being used, but vertical axis (Darrieus) type of turbines have limited usage because they are lift driven. It is the powerlessness of the vertical axis (Darrieus) wind turbines to self-begin because of which they are less preferred for usage than horizontal or drag driven turbines. The primary defect with their outline is their powerlessness to self-begin. Darrieus turbines require an external energy source to bring the device to a minimum rotational speed.

There is a need to design and develop an apparatus for the generation of power to operate telecommunications network systems which solves the above mentioned problems and cost effective. Further, there is a need to develop an apparatus that utilizes a vertical axis wind turbine for generating electric power to operate telecommunications network systems.

### OBJECTS OF THE INVENTION

Some of the objects of the present disclosure are described herein below:

A main object of the present invention is to provide an apparatus for generating power to operate telecommunication networks using vertical axis wind turbines.

Another object of the present invention is to provide an apparatus that utilizes a Faraday Cage wrapped around the generator to protect the telecommunication network from electromagnetic interference and lightning.

Still another object of the present invention is to provide an apparatus that utilizes a hollow rotating vertical shaft to transfer the rotation of blades due to wind energy to the generator and thereby to convert the wind energy to electrical energy.

Yet another object of the present invention is to provide an apparatus that utilizes the hollow rotating vertical shaft is mounted on top of the telecommunication network for providing electrical power to the telecommunication network systems.

Another object of the present invention is to provide an apparatus that increase the amount of energy that the rotor can extract from the wind by increasing the rotor diameter.

Another object of the present invention is to provide an apparatus that a predetermined rotor diameter is designed to obtain a predetermined energy from the wind.

Another object of the present invention is to provide an apparatus for generating power to operate telecommunication networks with less maintenance and construction costs.

The other objects and advantages of the present invention will be apparent from the following description when read in conjunction with the accompanying drawings, which are incorporated for illustration of preferred embodiments of the present invention and are not intended to limit the scope thereof.

### SUMMARY OF THE INVENTION

In view of the foregoing, an embodiment herein provides an apparatus for generating power to operate telecommunication networks using vertical axis wind turbine. The apparatus comprises of, at least one vertical wind turbine, at least one generator, a gearbox and at least one Faraday cage. The vertical axis wind turbine (VAWT) may include but not limited to a hub, a hollow rotating vertical shaft, a rotor, a plurality of blades, and a brake mechanism. The hub is placed above the gearbox attached on the hollow rotating vertical shaft to which the plurality of blades is attached. The hollow rotating vertical shaft or shaft is connected to the hub that in turn connected to the generator. The shaft is mounted on top of the telecommunication network. The shaft is provided to transfer the rotation of blades due to wind energy to the generator and thereby to convert the wind energy to electrical energy. The Faraday cage is wrapped around the generator to avoid electromagnetic interference and lightning.

According to an embodiment, the hub for VAWT may include upper hub and lower hub to attach the blades at two points of the hollow rotating vertical shaft using upper bearing and lower bearing respectively. The hub is made of materials such as cast iron or cast steel. Further, increase in an overall diameter of the rotor increases the amount of energy that the rotor can extract from the wind. A predetermined rotor diameter is designed to obtain a predetermined energy from the wind. The blades are mainly made of materials such as aluminum, fiber glass or carbon fiber to provide better strength to weight ratio.

According to an embodiment, the gearbox provided for increasing speed of the hollow rotating vertical shaft thereby to increase the speed of the generator. The gearbox is made up of aluminum alloys, stainless steel and cost iron and so on. The gearbox includes plurality of gear stages that comprises planetary type, helical type, parallel shaft type, spur type and worm types. There are two or more gear types combined in multiple stages to achieve required speed.

According to an embodiment, the brake mechanism is provided on the shaft between the gearbox and the generator. The brake mechanism includes a mechanical drum brake or disk brake. The brake mechanism is provided on the shaft between the VAWT and the gearbox. The brake mechanism may include but is not limited to a mechanical drum brake, disk brake and so on. The generator utilized for the apparatus is three-phase induction generator.

According to an embodiment, the Faraday cage is made up of aluminum or copper sheets with a predetermined thickness which depends on the intensity of the radiation emitted in the telecommunication network. The Faraday cage converts incident radiation into current producing equal and opposite electromagnetic field to cancel out an existing electromagnetic field. The apparatus is provided with a battery backup for providing uninterrupted service for the telecommunication network.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates the perspective view of an apparatus for generating power to operate telecommunication networks, according to an embodiment herein;

FIG. 2 illustrates blades of Darrieus-type vertical axis wind turbine, according to an embodiment herein;

FIG. 3 illustrates the line diagram of an apparatus for generating power to operate telecommunication networks, according to an embodiment herein;

FIG. 4.1 illustrates the side view of an overall setup of an apparatus mounted on the telecommunication networks, according to an embodiment herein; and

FIG. 4.2 illustrates the perspective view of an overall setup of an apparatus mounted on the telecommunication networks, according to an embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

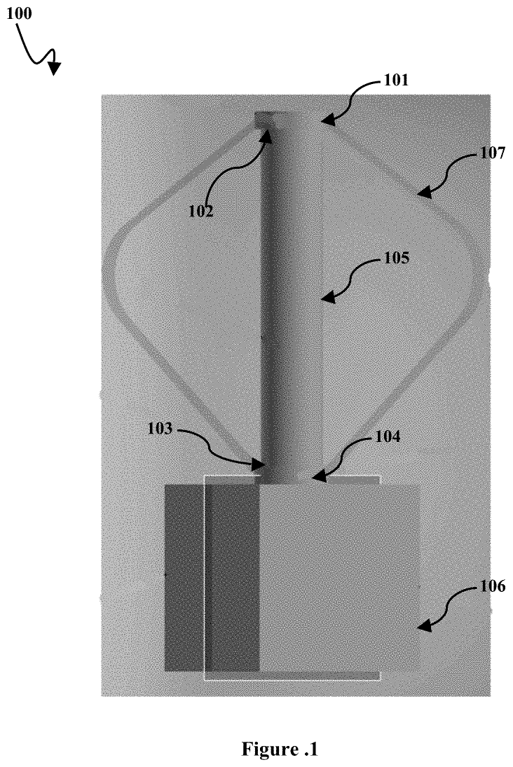

As mentioned above, there is a need for an apparatus for generating power to operate telecommunication networks. The embodiments herein achieve this by providing an apparatus for generating power to operate telecommunication networks using vertical axis wind turbine. Referring now to the drawings, and more particularly to FIGS. 1 through 4.2, where similar reference characters denote corresponding features consistently throughout the figures, there are shown preferred embodiments.

FIG. 1 illustrates the perspective view of an apparatus 100 for generating power to operate telecommunication networks, according to an embodiment. The apparatus for generating power to operate telecommunication networks using vertical axis wind turbine. The apparatus comprises of, at least one vertical wind turbine, at least one generator 302, a gearbox and at least one Faraday cage 106. The vertical wind turbine (VAWT) may include but is not limited to a hub, a hollow rotating vertical shaft 105 or shaft, a rotor, a plurality of blades 107, and a brake mechanism. The hub is placed above the gearbox attached on to the shaft to which the plurality of blades 107 is attached. The hollow rotating vertical shaft 105 or shaft 105 is connected to the hub that in turn connected to the generator 302. The shaft 105 is mounted on top of the telecommunication network. The shaft 105 is provided to transfer the rotation of blades 107 due to wind energy to the generator 302 and thereby to convert the wind energy to electrical energy. The Faraday cage 106 is wrapped around the generator 302 to avoid electromagnetic interference and lightning.

According to an embodiment, the hub for VAWT may include upper hub 101 and lower hub 104 to attach the blades 107 at two points of the hollow rotating vertical shaft 105 using upper bearing 102 and lower bearing 103 respectively. The hub is made of materials such as cast iron or cast steel. The rotor is the heart of a wind turbine and consists of multiple blades 107 attached to a hub. The rotor is responsible for collecting the energy present in the wind and transforming this energy into mechanical motion. Further, increase in an overall diameter of the rotor increases the amount of energy that the rotor can extract from the wind. A predetermined rotor diameter is designed to obtain a predetermined energy from the wind.

According to an embodiment, the Faraday cage 106 is made up of aluminum or copper sheets with a predetermined thickness which depends on the intensity of the radiation emitted in the telecommunication network. The Faraday cage 106 converts incident radiation into current producing equal and opposite electromagnetic field to cancel out an existing electromagnetic field. The apparatus is provided with a battery backup for providing uninterrupted service for the telecommunication network.

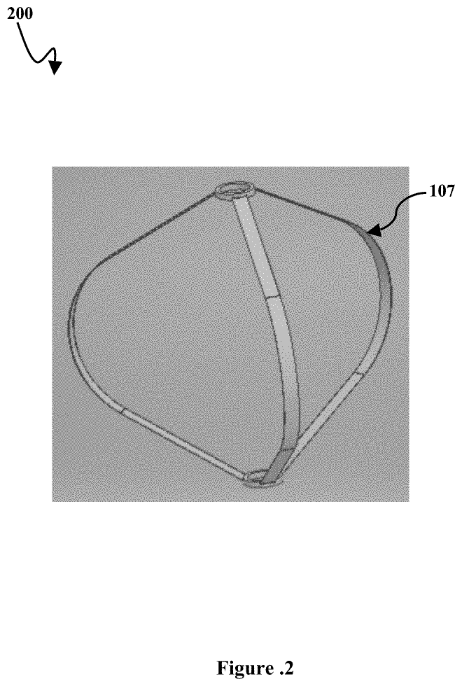

FIG. 2 illustrates blades 200 of Darrieus-type vertical axis wind turbine, according to an embodiment. The blades 107 are a crucial and basic part of the vertical axis wind turbine. The blades 107 of the Darrieus-type vertical axis wind turbine are having curved structure. The blades 107 are made of materials such as aluminum, fiber glass or carbon fiber to provide better strength to weight ratio. The design of the individual blades 107 also affects the overall design of the rotor. The blades 107 can take the energy out of the wind and the blade “capture” the wind and convert its kinetic energy into the rotation of the hub.

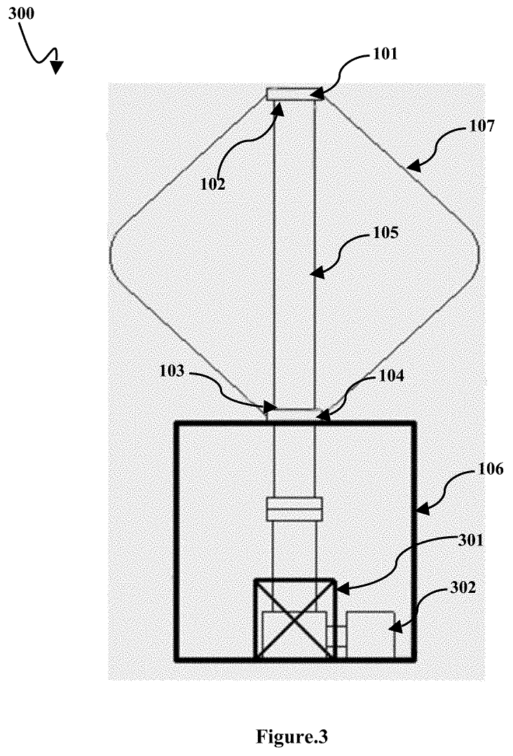

FIG. 3 illustrates the line diagram of an apparatus 300 for generating power to operate telecommunication networks, according to an embodiment. The line diagram shows the internal components present in the Faraday cage 106. The Faraday cage 106 covers the generator 302, the gearbox 301, and the brake mechanism. The gearbox 301 provided for increasing speed of the hollow rotating vertical shaft 105 thereby to increase the speed of the generator 302. The gearbox 301 is made up of aluminum alloys, stainless steel and cost iron and so on. The gearbox 301 includes plurality of gear stages that comprises planetary type, helical type, parallel shaft type, spur type and worm types. There are two or more gear types combined in multiple stages to achieve required speed.

According to an embodiment, the brake mechanism is provided on the shaft 105 between the gearbox 301 and the generator 302. The brake mechanism includes a mechanical drum brake or disk brake. The brake mechanism is provided on the shaft 105 between the VAWT and the gearbox 301. The brake mechanism may include but is not limited to a mechanical drum brake, disk brake and so on. The mechanical drum brake or disk brake is use to stop the turbine in emergency situation such as extreme gust events or over speed. This brake is also used to hold the turbine at rest for maintenance as a secondary mean, primarily mean being the rotor lock system.

According to an embodiment, the generator 302 utilized for the apparatus is three phase induction generator 302. The power output from the generator 302 is for example 10 Kw. In the wind turbine one of the major constraints taken into consideration is varying speed of wind. So, synchronous machines may not work effectively for varying speeds. Hence asynchronous machine is the best available choice and it is also proved that induction generator 302 suits best for variable speeds. However, single-phase induction machines will not work effectively for power ratings as high as 10 Kw. They are used only for low power ratings. Therefore, three-phase induction generator 302 is an ideal machine for a wind turbine of high power ratings. For example, the voltage rating depends on the voltage required by the base station and the current rating depends on the current rating of the base station. The Power rating may be 10 Kw. Further, speed of the generator 302 can be 250-500 RPM.

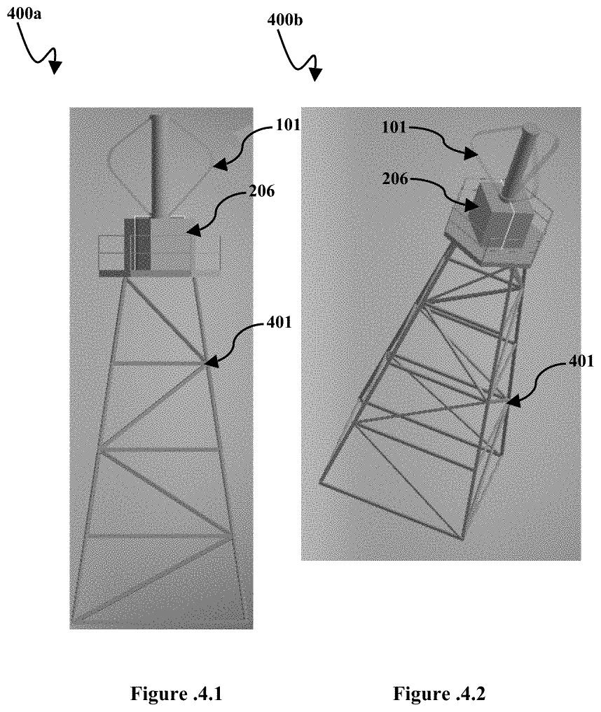

FIG. 4.1 illustrates the side view of an overall setup 400a of an apparatus mounted on the telecommunication networks, according to an embodiment. FIG. 4.2 illustrates the perspective view of an overall setup 400b of an apparatus mounted on the telecommunication networks, according to an embodiment. The apparatus is mounted on top of the telecommunication network system 401. The base of the vertical axis wind turbine is usually mounted on the top of a platform on which it is installed. The Faraday cage 106 is provided to protect the generator 302 from electromagnetic interference. Hence the generator 302 placed inside this Faraday cage 106 is free from radiations. And one more added advantage with this Faraday cage 106 is it protects the apparatus from lightning.

According to an embodiment, the design of the apparatus can increase the efficiency of the turbine. The apparatus allows user to deploy the Darrieus turbines/vertical axis wind turbine in real time environment, to configure and monitor the increase in power generation and efficiency. Further, the apparatus can provide a mechanism for self-starting of the Darrieus turbine which eliminates the requirement of an external energy source to bring the device to a minimum rotational speed. In addition to that, the apparatus can provide a solution to control the maintenance and construction costs. The design of the apparatus may provide solution to many of the problems with respect to cost, maintenance, radiations, powering and noise of the telecommunications tower associated the wind turbines.

Another object of the present invention is to provide a viable solution for increased power generation to satisfy power requirements in the future world. Further, the apparatus can be installed for telecommunication networks that includes but not limited to cellphone towers, telescopic mast, radio towers, mast towers, cellular towers, EMS service technology towers, navigation towers, television towers, global positioning satellite technology towers, mobile towers, radio signal transmission towers, high rise buildings and so on.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. An apparatus for generating power to operate telecommunication networks comprises of,
at least one vertical wind turbine, at least one generator (302) and at least one Faraday cage (106);
wherein the vertical axis wind turbine (VAWT) includes a hub, a hollow rotating vertical shaft (105), a rotor, a plurality of blades (107), and a brake mechanism;
wherein the hub attached on to the shaft to which the plurality of blades (107) are attached;
wherein the hollow rotating vertical shaft (105) connected to the hub that in turn connected to the generator (302);
wherein the hollow rotating vertical shaft (105) mounted on top of the telecommunication network system (401);
wherein the hollow rotating vertical shaft (105) provided to transfer the rotation of blades (107) due to wind energy to the generator (302) and thereby to convert the wind energy to electrical energy; and
wherein the Faraday cage (106) wrapped around the generator (302) to avoid electromagnetic interference and lightning.

2. The apparatus of claim 1, wherein the hub for VAWT includes upper hub (101) and lower hub (104) to attach the blades (107) at two points of the hollow rotating vertical shaft (105) using upper bearing (102) and lower bearing (103) respectively; and wherein the hub is made of materials such as cast iron or cast steel.

3. The apparatus of claim 1, wherein increase in an overall diameter of the rotor increases the amount of energy that the rotor can extract from the wind; and wherein a predetermined rotor diameter is designed to obtain a predetermined energy from the wind.

4. The apparatus of claim 1, wherein the blades (107) are mainly made of materials such as aluminum, fiber glass or carbon fiber to provide better strength to weight ratio.

5. The apparatus of claim 1, wherein the brake mechanism provided on the shaft and connected to the generator (302); and wherein the brake mechanism includes a mechanical drum brake or disk brake.

6. The apparatus of claim 1, wherein the generator (302) utilized for the apparatus in 3 phase induction generator (302).

7. The apparatus of claim 1, wherein the Faraday cage (106) is made up of aluminum or copper sheets with a predetermined thickness which depends on the intensity of the radiation emitted in the telecommunication network system (401).

8. The apparatus of claim 1, wherein the Faraday cage (106) converts incident radiation into current producing equal and opposite electromagnetic field to cancel out an existing electromagnetic field.

9. The apparatus of claim 1, wherein the apparatus is provided with a battery backup for providing uninterrupted service for the telecommunication network system (401).

10. The apparatus of claim 1, wherein the apparatus installed for telecommunication networks that includes cellphone towers, telescopic mast, radio towers, mast towers, cellular towers, EMS service technology towers, navigation towers, television towers, global positioning satellite technology towers, mobile towers, radio signal transmission towers, high rise buildings and so on.
